(19) United States
(12) Patent Application Publication
(10) Pub. No.: US 2019/0291084 A1
(43) Pub. Date: Sep. 26, 2019

(54) CATALYTIC REACTION

(71) Applicant: James Dorman, Baton Rouge, LA (US)

(72) Inventor: James Dorman, Baton Rouge, LA (US)

(21) Appl. No.: 16/412,119

(22) Filed: May 14, 2019

Related U.S. Application Data
(63) Continuation of application No. 15/970,659, filed on May 3, 2018.
(60) Provisional application No. 62/500,860, filed on May 3, 2017.

(51) Int. Cl. B01J 23/745; B01J 8/02; B01J 19/00; B01J 23/94; B01J 8/06; B01J 38/12

(52) U.S. Cl. CPC B01J 23/745; B01J 8/0292; B01J 19/0013; B01J 23/94; B01J 8/0221; C07B 33/00; B01J 8/067; B01J 8/0285; B01J 38/12; B01J 2208/00203; B01J 2208/00433; B01J 8/0278

(57) ABSTRACT

Reaction methods are disclosed including induction catalysts. Such reactions may involve heating a catalyst by inductive heating; contacting the catalyst with a composition such that a reaction occurs and removing a reaction product. Example reactions include catalysts with ferrimagnetic metal oxide material and reactions involving organic reactants.

Catalytic reaction methods and reactors described herein may be used in the catalytic reaction of organic compositions and may provide significant gains in energy efficiency for such reactions. In particular, such catalytic reactions may be useful in the dehydrogenation of hydrocarbons.

### BRIEF DESCRIPTION OF THE DRAWINGS

FIG. 1 shows a reactor setup.

FIG. 2 shows a cut away of a reactor tube.

FIG. 3 shows a partial cut away of a catalyst particle.

FIG. 4 shows gas chromatography-mass spectroscopy results for thermally activated reactions.

FIG. 5 shows Fourier transform infrared spectroscopy for a butanol reaction product.

FIG. 6 shows mass spectroscopy data for a butanol reaction product.

FIG. 7 shows fluorescence data for a butanol reaction product.

### DETAILED DESCRIPTION

### Example 1

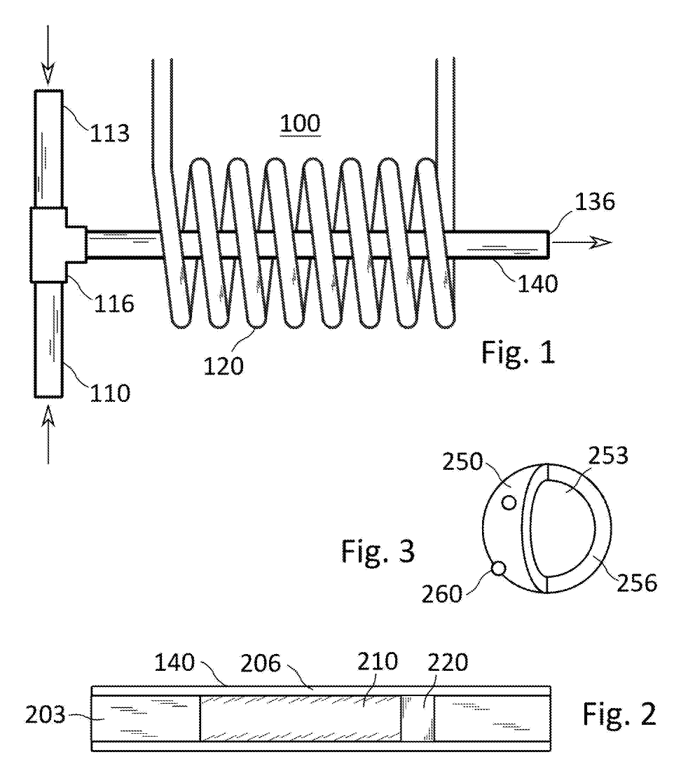

Referring to FIG. 1, Reactor 100 includes Oxidizer supply line 110, Feed gas line 113, T fitting 116, Induction heater coil 120, Reaction product outlet 136 and Reaction tube 140. Oxygen or other gasses used to regenerate catalyst may be supplied from Oxidizer supply line 110. Such gases may be selected from oxygen, carbon dioxide or combinations thereof. Other gases capable of regenerating Fe₂O₃ to Fe₃O₄ may be used as well. Regeneration would typically happen between reaction runs to restore the effectiveness of the catalyst. For that reason, the reactor setup depicted in FIG. 1 would typically supply gas from only one of Oxidizer supply line 110 and Feed gas line 113 at a time. Feed gas line 113 may deliver a metered supply of organic molecules and/or hydrocarbons through T fitting 116 to pass through Reaction tube 140 inside of Induction heater coil 120. Both Oxidizer supply line 110 and Feed gas line 113 may have mass flow control systems to control the delivery of gas to the reactor. The reactor may be configured to deliver a single reactant or more than one reactant with control and metering of such delivery. The reaction of the hydrocarbons takes place within Reaction tube 140 in the area heated by Induction heater coil 120 and the reaction products leave through Reaction product outlet 136.

FIG. 2 depicts the interior of Reaction tube 140 including Reaction tube inner surface 203, Reaction tube wall 206, Packed catalyst 210 and Glass wool packing 220. Reaction tube 140 is open to T fitting 116 and Reaction product outlet 136. (both shown in FIG. 1)

FIG. 2 is arranged to depict the configuration of Packed catalyst 210 and Glass wool packing 220 within Reaction tube wall 206. Glass wool packing 220 holds Packed catalyst 210 in position so that the catalyst can be influenced by inductive heating. The packing of the catalyst at Packed catalyst 210 in the figure may be a loose packing to permit the flow of gases through the catalyst.

FIG. 3 depicts Catalyst particle 250, shown in partially cut away form, which is predominantly made up of Catalyst particle core 253, Catalyst particle outer shell 256, and Decorations 260. Catalyst particle core 253 is surrounded by Catalyst particle outer shell 256 which may have a variety of Decorations 260 distributed around the outer surface of Catalyst particle outer shell 256. The catalyst particles depicted in FIG. 2 or variations therefrom may be situated in Reaction tube 140 as the Packed catalyst 210.

In one example, the Catalyst particle core 253 may be Fe₃O₄, the Catalyst particle outer shell 256 may be Mn₃O₄ and Decorations 260 may be platinum. In another example, the Catalyst particle core 253 may be Mn₃O₄ and the Catalyst particle outer shell 256 may be Fe₃O₄ and Decorations 260 may be platinum. The combinations of catalytic materials that may be used can have a significant variety. Examples of such materials and material combinations may include one or more materials that respond to inductive heating. Table 1 below lists a variety of examples of potential catalyst configurations.

TABLE 1

| | Core | Shell | Decoration |
|---|---|---|---|
| Example A | Fe₃O₄ | Fe₃O₄ | None |
| Example B | Fe₃O₄ | Fe₃O₄ | Pt |
| Example C | Fe₃O₄ | Fe₃O₄ | Pd |
| Example D | Fe₃O₄ | Fe₃O₄ | Au |
| Example E | Fe₃O₄ | Mn₃O₄ | None |
| Example F | Fe₃O₄ | Mn₃O₄ | Pt |
| Example G | Fe₃O₄ | Mn₃O₄ | Pd |
| Example H | Fe₃O₄ | Mn₃O₄ | Au |
| Example I | Mn₃O₄ | Fe₃O₄ | None |
| Example J | Mn₃O₄ | Fe₃O₄ | Pt |
| Example K | Mn₃O₄ | Fe₃O₄ | Pd |
| Example L | Mn₃O₄ | Fe₃O₄ | Au |
| Example M | Fe₃O₄ | Co₃O₄ | None |
| Example N | Fe₃O₄ | Co₃O₄ | Pt |
| Example O | Fe₃O₄ | Co₃O₄ | Pd |
| Example P | Fe₃O₄ | Co₃O₄ | Au |
| Example Q | Co₃O₄ | Fe₃O₄ | None |
| Example R | Co₃O₄ | Fe₃O₄ | Pt |
| Example S | Co₃O₄ | Fe₃O₄ | Pd |
| Example T | Co₃O₄ | Fe₃O₄ | Au |

As described in Table 1, catalyst particles having Fe₃O₄ as both the core and the shell are simply continuous Fe₃O₄ particles. It is further contemplated that the catalyst particles may be in a variety of shapes including spheres, cubes, plates, pyramids and other forms. Further, the catalyst particles may be conformal, having a relatively uniform geometry, or may be non-conformal, allowing for a large number of points of metal-metal interface as potential reaction sites. Other catalyst particles having geometric forms demonstrating particular suitability for high-efficiency inductive heating may also be used. Catalyst particles may be between 20 nm and 100 μm. The catalytic particles may be weak magnets or soft magnets. The catalytic particles may contain ferrimagnetic materials or ferromagnetic materials. The catalytic particles may be characterized as ferrimagnetic, ferromagnetic or superparamagnetic. Magnetic particles with stronger magnetic fields than the Fe₃O₄ particles may have smaller particle sizes. Further, nickel and other catalytic materials may be used in the place of the non-superparamagnetic catalytic material described in the Table 1 and may be used in other described catalytic materials.

A material's suitability to serve as the material that responds to inductive heating within the catalyst may be characterized by the specific loss power of the material within a 10 kW inductive coil heater operating at 280 kHz. The specific loss power of the material that responds to inductive heating within the catalyst under such circumstances may be greater than 50 W/g. In many cases the specific loss power of the material that responds to inductive heating within the catalyst under such circumstances may be greater than 500 W/g. In many cases the specific loss power of the material that responds to inductive heating within the catalyst under such circumstances may be greater than 2000 W/g.

The present reactor may be configured such that controlled heating of the surface of nanoparticles within the reactor is achieved. Ferrimagnetic and superparamagnetic materials within the nanoparticles respond to the inductive heating and heat the catalyst. Any one of iron oxide, manganese oxide and cobalt oxide or combinations thereof may be used as the heating material within the catalyst. The examples of Table 1 use Fe₃O₄ as the material that responds to inductive heating within the catalyst. However, the examples of Table 1 may be modified such that any of iron oxide, manganese oxide and cobalt oxide or combinations thereof may be used as the material that responds to inductive heating within the catalyst. Nickel oxide may also be used as the magnetic material. The presence of such materials within the catalyst allows for precise temperature control by controlling factors such as frequency and pulse length of the induction coil. Fe₃O₄ may serve as the active catalyst in the dehydrogenation of hydrocarbons. Reaction temperatures in the reactor may be significantly below temperatures conventionally associated with processing hydrocarbons. The temperature of the reactor may be below 300° C. Further, the reactor feed may be less than 250° C. and in certain cases may be less than 100° C. By controlling the pulsed stimulation of the inductive coil, specific hydrocarbon conversions or conversions of other organic molecules may be selected and fouling and or degradation of the catalyst may be avoided or delayed. Pulses of power to the inductive coil may be used to raise the temperature of the catalyst for a short period of time followed by a period of no heating and such pulsing may be used to select for specific reaction products and to avoid coking of the catalyst. Control of the pulsed stimulation of the inductive coil may be varied for different pulsing patterns and different pulsing frequencies. The control of the stimulation of the inductive coil may be regulated for the selection of particular reaction products.

Reaction tube 140 may, for example, be one of many such similar reaction tubes bundled or otherwise configured to pass through the inductive heating coil. The reactor may be scaled up to larger commercial embodiments by a variety of methods including multiplying the number of reaction tubes within an induction coil, increasing the total number of induction coil reactor systems or both. Reaction tube 140 may, for example, be a ¼ inch quartz tube. Variations in the size of the individual reactor tube are also contemplated.

The reactor may be insulated in various ways including the use of glass tubes, rubber insulation and other insulating materials that do not interfere with the inductive heating. Further, the coil may be water cooled and components may be air cooled.

The feed gas introduced through Feed gas line 113 may for example be methane, ethane, propane or mixtures thereof. Other examples of the feed gas may include any hydrocarbon or other organic molecules that are gaseous at temperatures below 200° C. Feed rates may be optimized based on the feed gas, the particular reaction product selected for production, economic and other considerations. The reactor may have substantial utility for the dehydrogenation of hydrocarbons and various other reactions involving organic reactants. The reactor may have further utility for endothermic reactions generally and may have particular utility for endothermic reactions where high temperatures would otherwise be required.

### Example Set 2

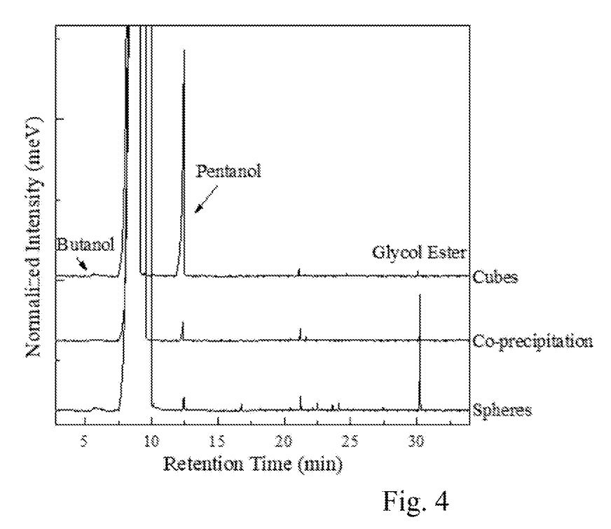

Catalytic reaction experiments were performed using a conventional furnace and an induction heating system. The conventional reaction is denoted as thermally activated while the induction heating reaction can be referred to as Radio-Frequency (RF) activated. For the thermal reaction experiments, a solution containing iron oxide (Fe₃O₄) nanoparticles and butanol was placed in a 20-mL Teflon lined glass vial. The iron oxide (Fe₃O₄) nanoparticles were synthesized via thermal decomposition, particularly using colloidal routes. The butanol was 99% pure and obtained from Alfa Aesar. The solution concentration was 50 mg/mL and the glass vial was sealed in air before it was placed in a pre-heated furnace at 200° C. Once the sealed glass vial was in the oven, the oven was maintained at 200° C. for up to 12 hours. Additional experiments were conducted testing reaction conditions associated with a 200° C. oven temperature and reaction times of up to 24 hours. Then, the glass vial was removed from the oven and cooled naturally. The products of this reaction were obtained by separating the resultant liquid solution from the Fe₃O₄ nanoparticles via magnetic separation. The thermally activated experiments were conducted with various shapes of Fe₃O₄ nanoparticles including spherical particles, cubes and co-precipitation, which represents a shape mixture which is less well defined than cubes or spheres. The reaction products from the reactions were analyzed via Gas Chromatography-Mass Spectroscopy (GC-MS), and the results are shown in FIG. 4. The varying results in FIG. 4 demonstrate that product selectivity is present based upon shape. The peaks in

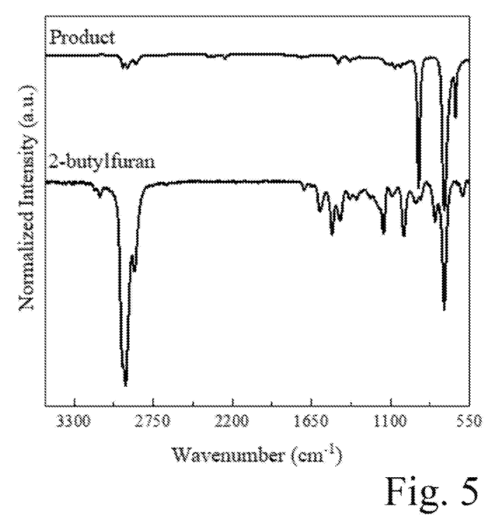

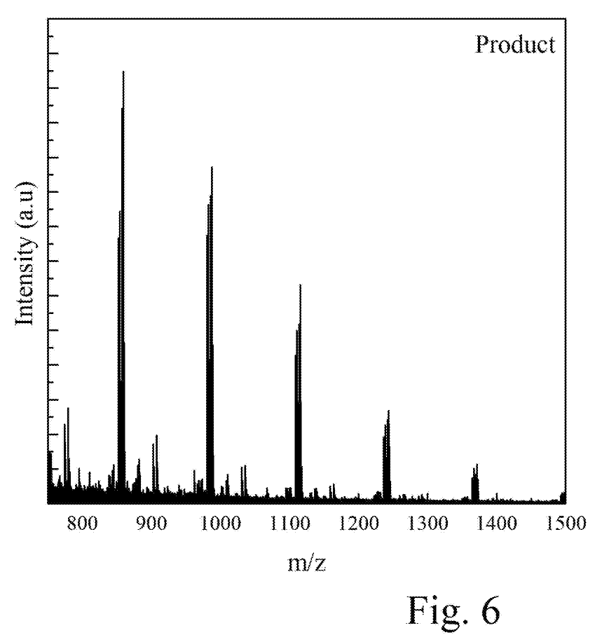

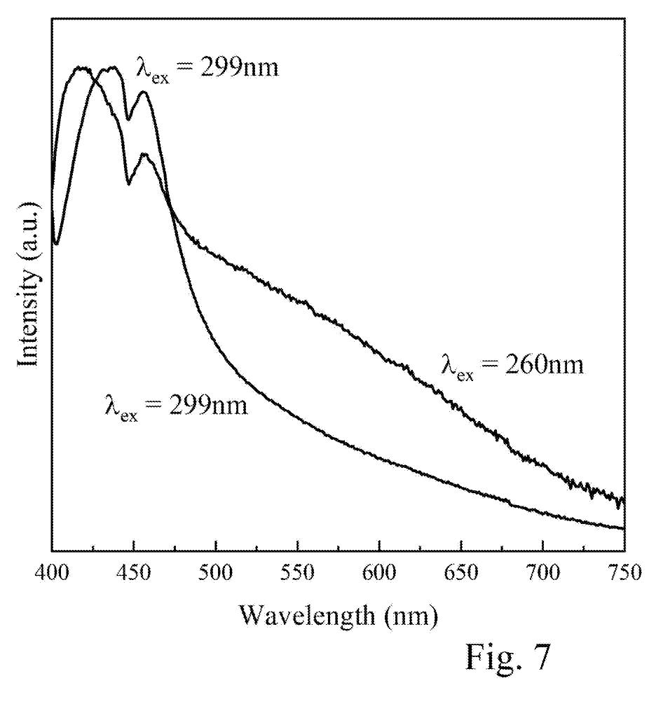

At least one furan type product has been identified with the spherical particles when 50 mg/ml Fe₃O₄ to butanol was sealed in a glass vial and heated at 200° C. for up to 24 hrs. That furan type product may be present in some or all of the experiments of Example Set 2. The products had substituted furan signatures, as shown by the Fourier Transform Infrared Spectroscopy (FTIR). Similarities between a standard spectrum and the experimental data were observed at 646, 731 and 900 cm⁻¹, indicating the presence of furan species among other unidentified structures as shown by FIG. 5. The FTIR of 2-butyl furan is shown in FIG. 5 as a reference for comparison to the FTIR of the product. Depending on what type of catalytic material was used, different products were formed, indicating a change in selectivity. Although FIG. 5 is based on the thermal reaction pathway, radio frequency experiments indicate that there may be even greater selectivity toward furan type products when that pathway is used. Analysis via Inelastic Neutron Scattering (data not shown) have supported formation of a double bond, however, further details on the product characterization are needed to fully describe the reaction mechanism. The butanol catalyzed by spherical particles at 200 C for up to 24 hrs showed polimerization as evidenced by FIG. 6. That figure shows polymerization of butanol through the addition of two molecules condensing and the removal of water. The peaks in FIG. 6 separated by roughly 130 g/mol reflect the presence of two butanol molecules less a water molecule. The higher molecular weights (up to 1369 g/mol) compared to butanol (74 g/mol) also demonstrate the presence of polymerization. The butanol molecules appear to have been polymerized two molecules at a time via the cyclization and removal of water. The resultant molecules displayed fluorescence under UV-light emitting a blue/white appearance as evidenced by the emission spectrum data shown in FIG. 7 for reactions with spherical particles at 200° C. for 24 hrs. The butanol appears to form a polymer due to the bridging of the butanols and the removal of water.

RF activated reactions were performed in an induction heater. The induction heater used was a 10 kW model available from Ambrell Corporation as the Ambrell EASYHEAT 8130LI 10 kW. This system was composed of a cooler that ran water through the heating coil, and the coil used was controlled by a workhead in which the amperage can be chosen from 0-600 A. The frequency is determined by the coil used, and the one utilized in these reactions had a 0.035 m diameter and three turns, operating at a constant frequency of 343 kHz. The same solution of nanoparticles and butanol used in the thermal reactions were used for the RF activated reactions. Namely, a 10-mL scintillation vial with a septum cap was sealed in air and placed in the center of the coil. The amperage was varied up to 600 A which corresponds to a magnetic fields greater than 40 mT. The reaction was allowed to occur for up to five hours.

Additionally, a 5-mL glass vial was used as a reaction vessel to study the effect of the atmosphere on the RF activated reaction. The same solution was placed in the glass vial, and then bubbled with Argon gas for 20 minutes to displace the oxygen in the vial and create an inert atmosphere. Sufficient analysis has not yet been conducted to determine the full importance of inert reaction conditions, but the reaction may proceed at inert conditions, under various pressures or both. The glass vial was then immediately sealed and placed in the center of the coil and the experiment was run as described above.

Reaction methods described herein may, for example, comprise heating a catalyst by inductive heating; contacting the catalyst with a composition and removing a reaction product from a space encompassing the catalyst such that the catalyst comprises a superparamagnetic metal oxide material; the superparamagnetic metal oxide material makes up at least 20% of the catalyst by weight; the composition comprises a quantity of saturated hydrocarbon; the reaction product comprises a quantity of unsaturated hydrocarbon and the composition is less than 300° C. prior to contacting the composition with the catalyst. In a related example, the catalyst may comprise particles between 20 nm and 100 μm. In a related example, the catalyst may comprise Fe₃O₄. In a related example, the reaction method may further comprise regenerating the catalyst by contacting the catalyst with an oxidizer. In a related example, the contacting of the catalyst with the composition may take place within an insulated reactor. In a related example, the contacting of the catalyst with the composition may result in an exothermic reaction.

Reaction methods described herein may, for example, comprise heating a catalyst by inductive heating; contacting the catalyst with a composition such that a reaction occurs and removing a reaction product from a space encompassing the catalyst such that the catalyst comprises a superparamagnetic metal oxide material; such that the superparamagnetic metal oxide material makes up at least 20% of the catalyst by weight; such that the composition comprises a quantity of organic molecules without double bonds; such that the reaction product comprises a quantity of organic molecules with double bonds and such that the superparamagnetic metal oxide material has a specific loss power greater than 50 W/g. In a related example, the composition may be less than 300° C. prior to contacting the composition with the catalyst. In a related example, the reaction method may further comprise regenerating the catalyst by contacting the catalyst with an oxidizer. In a related example, the inductive heating may comprise pulses of inductive heat. In a related example, the contacting of the catalyst with the composition may take place within an insulated reactor. In a related example, the contacting of the catalyst with the composition may result in an exothermic reaction. In a related example, the contacting of the catalyst with the composition may result in a dehydrogenation reaction. In a related example, the contacting of the catalyst with the composition may result in an exothermic dehydrogenation reaction.

Reaction methods described herein may, for example, comprise heating a catalyst by inductive heating; contacting the catalyst with an organic composition such that a reaction occurs and removing a reaction product from a space encompassing the catalyst such that the catalyst comprises a ferrimagnetic metal oxide material; the ferrimagnetic metal oxide material makes up at least 20% of the catalyst by weight; wherein the reaction product comprises a quantity of organic molecules and the ferrimagnetic metal oxide material has a specific loss power greater than 50 W/g.

Reaction methods described herein may, for example, comprise introducing an alcohol into a reactor; introducing iron oxide into the reactor; regulating a reactor temperature such that it reaches between 100° C. and 300° C. and maintaining the reactor temperature between 100° C. and 300° C. for a time period sufficient to polymerize the alcohol such that a first product of the polymerizing of the alcohol is a cyclic compound and such that the first product of the polymerizing of the alcohol exhibits fluorescence. In a related example, the alcohol is butanol. In a related example, the alcohol is selected from butanol, pentanol and hexanol. In a related example, the maintaining of the reactor temperature is between 150 and 250° C. In a related example, radio-frequency heating is used in the maintaining of the reactor temperature. In a related example, the iron oxide is Fe₃O₄ nanoparticles. In a related example, the iron oxide is Fe₃O₄ particles that are less than 10 micrometers. In a related example, the maintaining of the reactor temperature between 100° C. and 300° C. occurs for at least 4 hours. In a related example, the polymerizing of the alcohol occurs as a batch processing reaction. In a related example, a majority of the iron oxide is spherical particles. In a related example, a majority of the iron oxide is cube particles. In a related example, a majority of the iron oxide is Fe₃O₄ nanoparticles. In a related example, the first product is a heterocyclic compound. In a related example, the first product contains a five-member ring structure. In a related example, the first product contains a furan ring. In a related example, a higher molecular weight alcohol is produced along with the first product. In a related example, a glycol ester is produced along with the first product. In a related example, the first product of the polymerizing of the alcohol exhibits fluorescence when exposed to 299 nm wavelength light. In a related example, the first product of the polymerizing of the alcohol exhibits fluorescence when exposed to 260 nm wavelength light.

The above-described embodiments have several independently useful individual features that have particular utility when used in combination with one another including combinations of features from embodiments described separately. There are, of course, other alternate embodiments which are obvious from the foregoing descriptions, which are intended to be included within the scope of the present application.

What is claimed is:

1. A low temperature method of polymerizing alcohol comprising:
a. introducing an alcohol into a reactor;
b. introducing iron oxide into the reactor;
c. regulating a reactor temperature such that it reaches between 100° C. and 300° C. and
d. maintaining the reactor temperature between 100° C. and 300° C. for a time period sufficient to polymerize the alcohol;
e. wherein a first product of the polymerizing of the alcohol is a cyclic compound and
f. wherein the first product of the polymerizing of the alcohol exhibits fluorescence.

2. The method of claim 1 wherein the alcohol is butanol.

3. The method of claim 1 wherein the alcohol is selected from butanol, pentanol and hexanol.

4. The method of claim 1 wherein the maintaining of the reactor temperature is between 150 and 250° C.

5. The method of claim 1 wherein radio-frequency heating is used in the maintaining of the reactor temperature.

6. The method of claim 1 wherein the iron oxide is Fe₃O₄ nanoparticles.

7. The method of claim 1 wherein the iron oxide is Fe₃O₄ particles that are less than 10 micrometers.

8. The method of claim 1 wherein the maintaining the reactor temperature between 100° C. and 300° C. occurs for at least 4 hours.

9. The method of claim 1 wherein the polymerizing of the alcohol occurs as a batch processing reaction.

10. The method of claim 1 wherein a majority of the iron oxide is spherical particles.

11. The method of claim 1 wherein a majority of the iron oxide is cube particles.

12. The method of claim 1 wherein a majority of the iron oxide is Fe₃O₄ nanoparticles.

13. The method of claim 1 wherein the first product is a heterocyclic compound.

14. The method of claim 1 wherein the first product contains a five-member ring structure.

15. The method of claim 1 wherein the first product contains a furan ring.

16. The method of claim 1 wherein a higher molecular weight alcohol is produced along with the first product.

17. The method of claim 1 wherein a glycol ester is produced along with the first product.

18. The method of claim 1 wherein the first product of the polymerizing of the alcohol exhibits fluorescence when exposed to 299 nm wavelength light

19. The method of claim 1 wherein the first product of the polymerizing of the alcohol exhibits fluorescence when exposed to 260 nm wavelength light.
